(19) United States
(12) Patent Application Publication
(10) Pub. No.: US 2017/0353050 A1
(43) Pub. Date: Dec. 7, 2017

(54) Automatic Medium-Voltage Dual-Power-Supply Switching Device

(71) Applicant: Midas Electric (Shanghai) Co., Ltd., Shanghai (CN)

(72) Inventors: Xin WANG, Shanghai (CN); Meng JIAO, Shanghai (CN)

(21) Appl. No.: 15/534,479

(22) PCT Filed: Dec. 4, 2015
(86) PCT No.: PCT/CN2015/096401

§ 371 Date: Jun. 8, 2017

(30) Foreign Application Priority Data
Dec. 9, 2014 (CN) 201420771155.0

(51) Int. Cl. H02J 9/06

(52) U.S. Cl. CPC H02J 9/061

(57) ABSTRACT

An automatic medium-voltage dual-power-supply switching device includes an input module, an acquisition module, a control and communication module, an output module, and a power supply module. The acquisition module includes a plurality of voltage input channels and a plurality of current input channels. The input module is used for receiving a first switch amount signal. The acquisition module is used for acquiring information, including a voltage, frequency and current. The output module is used for outputting a second switch amount signal. The communication module is used for communicating with a peripheral equipment. The power supply module is used for supplying power to the input module, the acquisition module, the communication module and the output module. The switching device, which not only can measure a voltage signal, but also can measure a current signal, has extensible voltage input channels and current input channels at the same time. A touch screen can also display the acquired information in a graphic manner, which is intuitive and clear.

### CROSS REFERENCE OF RELATED APPLICATION

This is a non-provisional application that claims the benefit of priority under 35 U.S.C. §371 to international application number PCT/CN2015/096401, international filing date Dec. 4, 2015, wherein the entire contents of each of which are expressly incorporated herein by reference.

### NOTICE OF COPYRIGHT

A portion of the disclosure of this patent document contains material which is subject to copyright protection. The copyright owner has no objection to any reproduction by anyone of the patent disclosure, as it appears in the United States Patent and Trademark Office patent files or records, but otherwise reserves all copyright rights whatsoever.

### BACKGROUND OF THE PRESENT INVENTION

### Field of Invention

The present invention relates to a power-supply switch, and more particularly to an automatic medium-voltage dual-power-supply switching device of 3 kV-35 kV.

### DESCRIPTION OF RELATED ARTS

Emergency power supply is the important power supply employed in buildings for emergency lighting, accident illumination, fire equipment, and etc., which is able to provide emergency power under emergency state. Code for Electrical Design of Civil Buildings (China) specifies that a first order load shall be powered by two power sources and, when a power source fails, the other power source should not be affected. The forms of first order load are two high-voltage power sources and one high-voltage power source plus one low-voltage power source, diesel dynamo set, and accumulator cell set. A specially important load in a first order load besides the above two power sources is a mandatory additional emergency power supply. Common emergency power supply includes an EPS (Emergency Power Supply), a UPS (Uninterruptible Power Supply), a self-prepared emergency diesel dynamo set, a special feeder that is independent from the regular power source and has an automatic input device, and a self-prepared emergency gas turbine generator set.

An automatic medium-voltage dual-power-supply switching device is mainly utilized in an emergency power supply system. When undervoltage, collapse of voltage, or power failure occurs to a regular power source, it will switch the load circuit to the emergency power source. When the regular power source is restored, it will switch the load circuit from the emergency power source back to the regular power source, so as to ensure the important load functions continually and reliably. However, conventional automatic medium-voltage dual-power-supply switching device can only acquire voltage signals of the two power sources, the regular power source and the emergency power source, and only allow the maximum of six measurement channels for voltage input, which quantity is not extensible as well.

### SUMMARY OF THE PRESENT INVENTION

Technical issues that the present invention aims to solve comprises overcoming the drawbacks that conventional automatic medium-voltage dual-power-supply switching device has limited quantity of measurement channel of the voltage input thereof and can only acquire voltage signal. Accordingly, the present invention provides an automatic medium-voltage dual-power-supply switching device, which is able to not only acquire voltage signals, but also acquire current signals and has extensible quantity of voltage input channel.

The present invention utilizes the following technical solutions to solve the above technical issues.

An automatic medium-voltage dual-power-supply switching device, comprises an input module, an acquisition module, a communication module, an output module, and a power supply module, wherein the acquisition module comprises a plurality of voltage input channels and a plurality of current input channels.

The input module is used for receiving a first switch amount signal. The acquisition module is used for acquiring information, wherein the information includes voltage, frequency, and current. The output module is used for outputting a second switch amount signal. The communication module is used for communicating with external devices. The power supply module is used for supplying power to the input module, the acquisition module, the communication module, and the output module.

In a preferred embodiment, the input module is utilized to receive the first switch amount signal. The input module is electrically connected with external switching device. The first switch amount signal is to represent an on-off state of the external switching device. The automatic medium-voltage dual-power-supply switching device according to the present invention is electrically connected with the regular power source, emergency power supply, or other power source(s). The acquisition module is utilized to acquire the voltage information and frequency information of the above power source(s) and to acquire the current information of the load circuit that is electrically connected with the automatic medium-voltage dual-power-supply switching device according to the present invention.

Preferably, the automatic medium-voltage dual-power-supply switching device further comprises a touch screen, utilized for communicating with the communication module. The touch screen is a color touch screen. When the color touch screen communicates with the communication module of the automatic medium-voltage dual-power-supply switching device, the color touch screen will be utilized to present the message of the information acquired by the acquisition module, comprising voltage, frequency, current, etc., in a graphic manner. The user can also check the work log of the automatic medium-voltage dual-power-supply switching device through the touch screen. In other words, logs like the collected voltage information of the power source in a specific period by the automatic medium-voltage dual-power-supply switching device, power switching at a particular moment, and etc., are all allowed to be reviewed.

Preferably, the communication interface has a communication interface built-in. The quantity of communication interface in the preferred embodiment of the present invention can be one or more, which all support IEC61850 standard protocol. The IEC61850 standard is the only international standard about automated transformer substation system based on universal communication protocol platform.

Preferably, the communication interface is a RJ-45 connector.

Preferably, the communication interface is a RS485 connector.

Preferably, the input module, the acquisition module, the communication module, the output module, and the power supply module are all on the same baseplate.

Preferably, the acquisition module comprises at least six voltage input channels and at least six current input channels.

Preferably, the acquisition module extensibly has up to sixty voltage input channels and up to sixty current input channels. The quantity of the voltage input channels according to the present invention can be expanded to sixty.

Preferably, the information further comprises active power, reactive power, and/or apparent power.

Preferably, the information further comprises power factor.

The advantages of the present invention, in comparison with conventional automatic medium-voltage dual-power-supply switching device, include that, the present invention not only can measure a voltage signal, but also can measure a current signal. In addition, it also has extensible voltage input channels and current input channels at the same time, and that a touch screen can display the acquired information in a graphic manner, which is intuitive and clear.

Still further objects and advantages will become apparent from a consideration of the ensuing description and drawings.

These and other objectives, features, and advantages of the present invention will become apparent from the following detailed description, the accompanying drawings, and the appended claims.

### BRIEF DESCRIPTION OF THE DRAWINGS

FIG. 1 is a schematic view of an automatic medium-voltage dual-power-supply switching device according to a prefered embodiment of the present invention.

### DETAILED DESCRIPTION OF THE PREFERRED EMBODIMENT

The following description is disclosed to enable any person skilled in the art to make and use the present invention. Preferred embodiments are provided in the following description only as examples and modifications will be apparent to those skilled in the art. The general principles defined in the following description would be applied to other embodiments, alternatives, modifications, equivalents, and applications without departing from the spirit and scope of the present invention.

The following provides a preferable embodiment with appended drawing to clearly and fully illustrate the present invention.

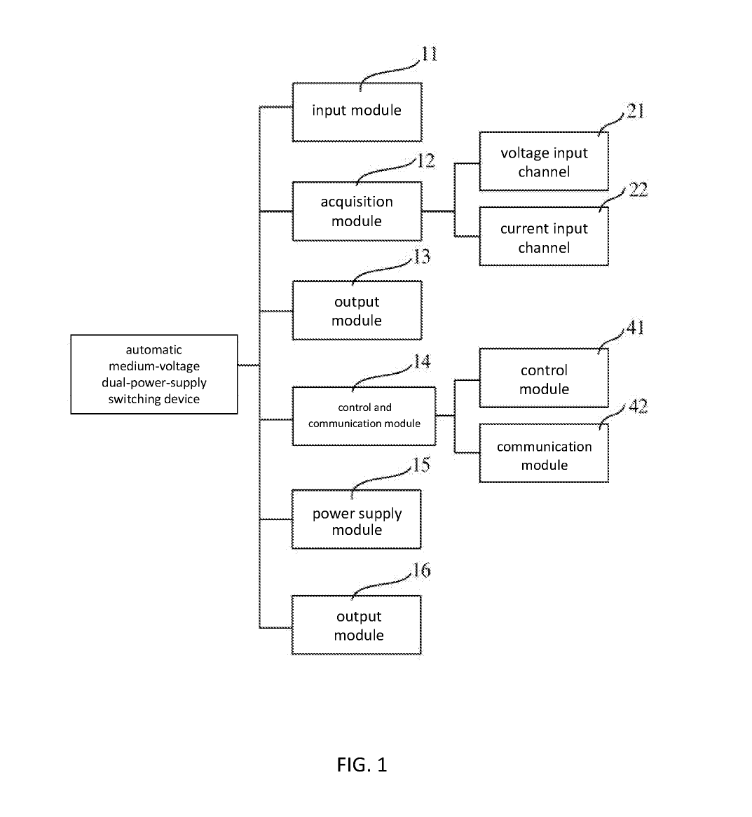

The structure of an automatic medium-voltage dual-power-supply switching device is illustrated in FIG. 1, which comprises an input module 11, an acquisition module 12, an output module 13, a control and communication module 14, a power supply module 15, and a touch screen 16. The acquisition module 12 comprises sixty voltage input channels 21 and sixty current input channels 22. The control and communication module 14 comprises a control module 41 and a communication module 42, wherein the communication module 42 has a RJ-45 connector and a RS485 connector built-in.

The power supply module 15 is utilized to supply power to the input module 11, the acquisition module 12, the control and communication module 14, and the output module 13. The input module 11, the acquisition module 12, the output module 13, the control and communication module 14, and the power supply module 15 are all on the same baseplate.

The input module 11 is utilized to receive a first switch amount signal and to transmit the first switch amount signal to the control module of the automatic medium-voltage dual-power-supply switching device according to the preferred embodiment of the present embodiment via the baseplate. The voltage input channel 21 is utilized for acquiring voltage information. The current input channel 22 is utilized for acquiring current information. The acquisition module 12 transmits the acquired voltage information and current information to the control module 41 via the baseplate. The control module 41 analyzes, processes and judges the first switch amount signal, the voltage information and the current information. For example, when the voltage value of the power source is lower than 75% of the normal value, it will determine that the power source is in an undervoltage condition and send a command to the communication module 42 and the output module 13, wherein the communication module 42 is utilized to send the information that the power source is in an undervoltage condition to the touch screen 16 or other external devices. The touch screen 16 will present the information in a graphic manner. The output module 13 is utilized to output a second switch amount signal to switch power source, so as to ensure the load circuit function normally. The control module can calculate the active power, reactive power, apparent power, power factor, and etc., based on the voltage information and current information. The control module also has real-time communication with the communication module. The communication module is utilized to present the real-time voltage value of the power source or the real-time current value of the load circuit in a graphic manner, such that the user can directly and clearly see the tendencies of the voltage value, current value, and etc. Besides, the acquisition module can also process the acquired voltage information and current information and transmit the processed information to the control module. The control module will further process the first switch amount signal and the information processed by the acquisition module. The range of the voltage value acquired by the acquisition module according to the present embodiment is 0 to 120V, and the range of the acquired current value is 0 to 10 A of alternating current.

The input module, the acquisition module, the control and communication module, the output module, and the power supply module in the automatic medium-voltage dual-power-supply switching device according to the preferred embodiment of the present embodiment can be embodied as one module or a plurality of modules respectively. The input module and the output module can be integrated into one module.

Although the above described specific implementation of the present invention, person skilled in the art should understand that the above are just embodiment(s) and implementations of the present invention may have modifications or changes in any ways without going against the above notions. Therefore, the protection scope of the present invention shall only be limited according to the appended claims.

One skilled in the art will understand that the embodiment of the present invention as shown in the drawings and described above is exemplary only and not intended to be limiting.

It will thus be seen that the objects of the present invention have been fully and effectively accomplished. The embodiments have been shown and described for the purposes of illustrating the functional and structural principles of the present invention and is subject to change without departure from such principles. Therefore, this invention includes all modifications encompassed within the spirit and scope of the following claims.

1-10. (canceled)

11. An automatic medium-voltage dual-power-supply switching device, comprising:
an input module receiving a first switch amount signal;
an acquisition module, which comprises a plurality of voltage input channels and a plurality of current input channels, acquiring information, including voltage, frequency and current;
a communication module adapted for communicating with external devices;
an output module outputting a second switch amount signal; and
a power supply module supplying power to said input module, said acquisition module, said communication module and said output module.

12. The automatic medium-voltage dual-power-supply switching device, as recited in claim 11, further comprising a touch screen, communicating with said communication module.

13. The automatic medium-voltage dual-power-supply switching device, as recited in claim 11, wherein said communication module has a communication interface built-in.

14. The automatic medium-voltage dual-power-supply switching device, as recited in claim 12, wherein said communication module has a communication interface built-in.

15. The automatic medium-voltage dual-power-supply switching device, as recited in claim 13, wherein said communication interface is selected from the group consisting of a RJ-45 connector and a RS485 connector.

16. The automatic medium-voltage dual-power-supply switching device, as recited in claim 14, wherein said communication interface is selected from the group consisting of a RJ-45 connector and a RS485 connector.

17. The automatic medium-voltage dual-power-supply switching device, as recited in claim 11, wherein said input module, said acquisition module, said communication module, said output module and said power supply module are provided on a baseplate.

18. The automatic medium-voltage dual-power-supply switching device, as recited in claim 16, wherein said input module, said acquisition module, said communication module, said output module and said power supply module are provided on a baseplate.

19. The automatic medium-voltage dual-power-supply switching device, as recited in claim 11, wherein said acquisition module comprises at least six voltage input channels and at least six current input channels.

20. The automatic medium-voltage dual-power-supply switching device, as recited in claim 16, wherein said acquisition module comprises at least six voltage input channels and at least six current input channels.

21. The automatic medium-voltage dual-power-supply switching device, as recited in claim 18, wherein said acquisition module comprises at least six voltage input channels and at least six current input channels.

22. The automatic medium-voltage dual-power-supply switching device, as recited in claim 11, wherein said acquisition module extensibly has sixty or less voltage input channels and up to sixty current input channels.

23. The automatic medium-voltage dual-power-supply switching device, as recited in claim 18, wherein said acquisition module extensibly has sixty or less voltage input channels and up to sixty current input channels.

24. The automatic medium-voltage dual-power-supply switching device, as recited in claim 21, wherein said acquisition module extensibly has sixty or less voltage input channels and up to sixty current input channels.

25. The automatic medium-voltage dual-power-supply switching device, as recited in claim 1, wherein said information further includes one or more of active power, reactive power, and apparent power.

26. The automatic medium-voltage dual-power-supply switching device, as recited in claim 18, wherein said information further includes one or more of active power, reactive power, and apparent power.

27. The automatic medium-voltage dual-power-supply switching device, as recited in claim 23, wherein said information further includes one or more of active power, reactive power, and apparent power.

28. The automatic medium-voltage dual-power-supply switching device, as recited in claim 11, wherein said information further includes power factor.

29. The automatic medium-voltage dual-power-supply switching device, as recited in claim 18, wherein said information further includes power factor.

30. The automatic medium-voltage dual-power-supply switching device, as recited in claim 27, wherein said information further includes power factor.
